(19) United States
(12) Patent Application Publication
(10) Pub. No.: US 2023/0339042 A1
(43) Pub. Date: Oct. 26, 2023

(54) METHODS FOR LASER PROCESSING TRANSPARENT WORKPIECES USING RADIALLY VARIABLE LASER BEAM FOCAL COLUMNS

(71) Applicant: CORNING INCORPORATED, CORNING, NY (US)

(72) Inventors: Patrick Scott Leslie, Tucson, AZ (US); Craig John Mancusi Ungaro, Corning, NY (US)

(21) Appl. No.: 18/011,875

(22) PCT Filed: Jun. 18, 2021
(86) PCT No.: PCT/US2021/037977

§ 371 Date: Dec. 21, 2022

Related U.S. Application Data
(60) Provisional application No. 63/043,871, filed on Jun. 25, 2020.

(51) Int. Cl. B23K 26/0622; B23K 26/06; B23K 26/55

(52) U.S. Cl. CPC B23K 26/0622; B23K 26/0648; B23K 26/55

(57) ABSTRACT

A method of laser processing a transparent workpiece (160) includes directing a laser beam (112) into the transparent workpiece (160) wherein a portion of the laser beam (112) directed into the transparent workpiece (160) includes a laser beam focal column (113) and generates an induced absorption to produce a defect column (172) within the transparent workpiece (160), the laser beam focal column (113) having a radius of maximum beam intensity that is variable along a length of the laser beam focal column (113) such that the radius of maximum beam intensity has at least two non-zero angles of propagation with respect to a center line of the laser beam focal column (113) along the length of the laser beam focal column (113).

### CROSS REFERENCE TO RELATED APPLICATION

This application claims the benefit of priority under 35 U.S.C. § 119 of U.S. Provisional Application Ser. No. 63/043,871 filed on Jun. 25, 2020, the content of which is relied upon and incorporated herein by reference in its entirety.

### BACKGROUND

### Field

The present specification generally relates to apparatuses and methods for laser processing transparent workpieces.

### Technical Background

Glass and transparent materials are substrates that are becoming more desirable in micro-optical-electro-mechanical systems. This is due to glass's unique properties and ability to have a lot of variability from glass to glass. Some examples of these material characteristics are low coefficient of thermal expansion (CTE), thermal and electrical insulation, optical properties, chemical stability and ability to be bonded to different materials such as metals, silicon and other substrates. For a lot of these applications, holes of different shapes and sizes are desired for manufacturing purposes.

Due to the nature of current laser beam focusing techniques such as ablation via focused Gaussian beams, and laser damage and etch (LD&E) processes using Bessel and Vortex beams, through glass vias (TGV) and surface structures are limited to simple shapes due to time and cost. As glass substrates are becoming more desirable, more than traditional collimated vias are being considered for manufacturing purposes. Current techniques applied to these applications either take a long time (ablative processes), or are limited in the scope of shapes they can produce (LD&E processes). An example could be as simple as creating a conical TGV. Current technology uses additional masking and single-sided etching steps to achieve complex TGVs, increasing the time, cost, and complexity of the process.

Accordingly, a need exists for alternative improved methods for laser forming through substrate vias.

### SUMMARY

According to first aspect of the present disclosure a method of laser processing a transparent workpiece includes directing a laser beam into a transparent workpiece wherein a portion of the laser beam directed into the transparent workpiece includes a laser beam focal column and generates an induced absorption to produce a defect column within the transparent workpiece, the laser beam focal column having a radius of maximum beam intensity that is variable along a length of the laser beam focal column such that the radius of maximum beam intensity has at least two non-zero angles of propagation with respect to a centerline of the laser beam focal column along the length of the laser beam focal column.

A second aspect of the present disclosure includes the method of the first aspect, further including directing the laser beam through a phase altering sub-assembly prior to directing the laser beam into the transparent workpiece, wherein the phase altering sub-assembly include one or more optical elements configured to apply an axicon phase modification, a vortex phase modification, and a third phase modification.

A third aspect of the present disclosure includes the method of the second aspect, wherein the third phase modification is a focusing phase modification.

A fourth aspect of the present disclosure includes the method of the second aspect, wherein the third phase modification is a radially symmetric Airy phase modification.

A fifth aspect of the present disclosure includes the method of any of the second through fourth aspects, wherein the one or more optical elements of the phase altering sub-assembly include an axicon and a vortex phase plate and the axicon is configured to apply the axicon phase modification and the vortex phase plate is configured to apply the vortex phase modification.

A sixth aspect of the present disclosure includes the method of the fifth aspect, further including a third optical element configured to apply the third phase modification

A seventh aspect of the present disclosure includes the method of the sixth aspect, wherein the third optical element includes a radial Airy phase plate.

An eighth aspect of the present disclosure includes the method of the sixth aspect, wherein the third optical element includes a focusing lens.

A ninth aspect of the present disclosure includes the method of the fifth aspect, wherein the axicon is configured to apply the third phase modification.

A tenth aspect of the present disclosure includes the method of any of the fifth aspect through the ninth aspect, wherein the phase altering sub-assembly is disposed in an optical system further including a lens assembly comprising a first lens and a second lens and the vortex phase plate is disposed between the first lens and the second lens of the lens assembly.

An eleventh aspect of the present disclosure includes the method of any of the second aspect through the fourth aspect, wherein the one or more optical elements of the phase altering sub-assembly include one or more spatial light modulators and the one or more spatial light modulators are configured to apply at least one of the axicon phase modification, the vortex phase modification, and the third phase modification.

A twelfth aspect of the present disclosure includes the method of the eleventh aspect, wherein the one or more spatial light modulators are configured to apply each of the axicon phase modification, the vortex phase modification, and the third phase modification.

A thirteenth aspect of the present disclosure includes the method of the twelfth aspect, wherein a single spatial light modulator of the one or more spatial light modulators is configured to apply each of the axicon phase modification, the vortex phase modification, and the third phase modification.

A fourteenth aspect of the present disclosure includes the method of any of the previous aspects, wherein the laser beam focal column includes a uniform maximum intensity in the radius of maximum beam intensity along the length of the laser beam focal column.

According to a fifteenth aspect of the present disclosure a method of laser processing a transparent workpiece includes directing a laser beam into a transparent workpiece wherein a portion of the laser beam directed into the transparent workpiece includes a laser beam focal column and generates an induced absorption to produce a defect column within the transparent workpiece, the laser beam focal column having a radius of maximum beam intensity that has a non-monotonic variability along the length of the laser beam focal column.

A sixteenth aspect of the present disclosure includes the method of the fifteenth aspect further including directing the laser beam through a phase altering sub-assembly prior to directing the laser beam into the transparent workpiece, wherein the phase altering sub-assembly includes one or more optical elements configured to apply an axicon phase modification, a vortex phase modification, and a third phase modification.

A seventeenth aspect of the present disclosure includes the method of the sixteenth aspect wherein the one or more optical elements of the phase altering sub-assembly include one or more spatial light modulators and the one or more spatial light modulators are configured to apply at least one of the axicon phase modification, the vortex phase modification, and the third phase modification.

An eighteenth aspect of the present disclosure includes the method of the sixteenth aspect wherein the one or more optical elements of the phase altering sub-assembly include an axicon and a vortex phase plate and the axicon is configured to apply the axicon phase modification and the vortex phase plate is configured to apply the vortex phase modification.

A nineteenth aspect of the present disclosure includes the method of the eighteenth aspect wherein the one or more optical elements of the phase altering sub-assembly further include a third optical element is configured to apply the third phase modification and the third optical element comprises a radial Airy phase plate or a focusing lens.

According to a twentieth aspect of the present disclosure a method of laser processing a transparent workpiece includes forming a defect column in a transparent workpiece, wherein the defect column includes tapered end sections. Forming the defect column includes directing a laser beam into the transparent workpiece wherein a portion of the laser beam directed into the transparent workpiece includes a laser beam focal column and generates an induced absorption to produce the defect column within the transparent workpiece, the laser beam focal column comprising a radius of maximum beam intensity that is variable along a length of the laser beam focal column, tapering at a divergent angle at a first end of the laser beam focal column and tapering at a convergent angle at a second end of the laser beam focal column and etching the transparent workpiece with a chemical etching solution to separate a portion of the transparent workpiece along the defect column, thereby forming an aperture extending through the transparent workpiece, the aperture having an aperture radius that varies by 10% or less along a length of the aperture.

A twenty-first aspect of the present disclosure includes the method of the twentieth aspect wherein the aperture radius of the aperture is from 5 μm to 50 μm.

A twenty-second aspect of the present disclosure includes the method of the twentieth aspect or the twenty-first aspect, further including directing the laser beam through a phase altering sub-assembly prior to directing the laser beam into the transparent workpiece, wherein the phase altering sub-assembly includes one or more optical elements configured to apply an axicon phase modification, a vortex phase modification, and a third phase modification.

A twenty-third aspect of the present disclosure includes the method of any of the twentieth aspect through the twenty-second aspect, wherein the aperture radius varies by 1% or less along a length of the aperture.

A twenty-fourth aspect of the present disclosure includes the method of any of the twentieth aspect through the twenty-third aspect, wherein the laser beam focal column includes a uniform maximum intensity in the radius of maximum beam intensity along the length of the laser beam focal column.

Additional features and advantages of the processes and systems described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts an optical system for forming a laser beam focal column using a vortex phase modification and an axicon phase modification, according to one or more embodiments shown and described herein;

FIG. 1B schematically depicts a vortex phase mask and an axicon phase mask that may be implemented in the optical system of FIG. 1A, according to one or more embodiments shown and described herein;

FIG. 2A schematically depicts an example laser beam focal column formed using the optical assembly of FIG. 1A, according to one or more embodiments shown and described herein;

FIG. 2B schematically depicts a cross-sectional view of the Bessel-Vortex laser beam focal column of FIG. 2A, according to one or more embodiments shown and described herein;

FIG. 3A schematically another example optical assembly for forming a laser beam focal column using a vortex phase modification and an axicon phase modification, according to one or more embodiments shown and described herein;

FIG. 3B schematically depicts an example laser beam focal column formed using the optical assembly of FIG. 3A, according to one or more embodiments shown and described herein;

FIG. 3C schematically depicts a discontinuous vortex phase mask, according to one or more embodiments shown and described herein;

FIG. 3D schematically depicts a cross section of a laser beam focal column formed using the discontinuous vortex phase mask of FIG. 3C, according to one or more embodiments shown and described herein;

FIG. 4A schematically depicts an optical system for forming a laser beam focal column using a phase altering sub-assembly comprising a vortex phase plate, an axicon, and a third optical element, according to one or more embodiments shown and described herein;

FIG. 4B schematically depicts an optical system for forming a laser beam focal column using a phase altering sub-assembly comprising a spatial light modulator, according to one or more embodiments shown and described herein;

FIG. 5A schematically depicts an example laser beam focal column formed using one of the optical systems of FIGS. 4A and 4B, according to one or more embodiments shown and described herein;

FIG. 5B graphically depicts the radius of maximum beam intensity of the laser beam focal column of FIG. 5A as a function of position along the length of the laser beam focal column, according to one or more embodiments shown and described herein;

FIG. 5C schematically depicts an example focusing phase mask, according to one or more embodiments shown and described herein;

FIG. 5D schematically depicts an example defect column formed using the laser beam focal column of FIG. 5A, according to one or more embodiments shown and described herein;

FIG. 6A schematically depicts another example laser beam focal column formed using one of the optical systems of FIGS. 4A and 4B, according to one or more embodiments shown and described herein;

FIG. 6B schematically depicts an amplitude phase mask used to form the laser beam focal column of FIG. 6A, according to one or more embodiments shown and described herein;

FIG. 6C schematically depicts an example defect column formed using the laser beam focal column of FIG. 6A, according to one or more embodiments shown and described herein;

FIG. 7 schematically depicts an aperture formed in the transparent workpiece by chemically etching the defect column of FIG. 6C, according to one or more embodiments shown and described herein;

FIG. 8A schematically depicts a laser beam focal column, according to one or more embodiments shown and described herein;

FIG. 8B schematically depicts another laser beam focal column, according to one or more embodiments shown and described herein;

FIG. 8C schematically depicts another laser beam focal column, according to one or more embodiments shown and described herein;

FIG. 8D schematically depicts another laser beam focal column, according to one or more embodiments shown and described herein;

FIG. 8E schematically depicts another laser beam focal column, according to one or more embodiments shown and described herein;

FIG. 8F schematically depicts another laser beam focal column, according to one or more embodiments shown and described herein;

FIG. 8G schematically depicts another laser beam focal column, according to one or more embodiments shown and described herein;

FIG. 9A schematically depicts another laser beam focal column, according to one or more embodiments shown and described herein;

FIG. 9B schematically depicts another laser beam focal column, according to one or more embodiments shown and described herein;

FIG. 9C schematically depicts another laser beam focal column, according to one or more embodiments shown and described herein;

FIG. 10A schematically depicts another laser beam focal column, according to one or more embodiments shown and described herein;

FIG. 10B schematically depicts another laser beam focal column, according to one or more embodiments shown and described herein;

FIG. 10C schematically depicts another laser beam focal column, according to one or more embodiments shown and described herein;

FIG. 11A schematically depicts another laser beam focal column, according to one or more embodiments shown and described herein;

FIG. 11B schematically depicts another laser beam focal column, according to one or more embodiments shown and described herein;

FIG. 11C schematically depicts another laser beam focal column, according to one or more embodiments shown and described herein;

FIG. 11D schematically depicts another laser beam focal column, according to one or more embodiments shown and described herein;

FIG. 11E1 schematically depicts a cross section of the laser beam focal column of FIG. 11D, according to one or more embodiments shown and described herein;

FIG. 11E2 schematically depicts another cross section of the laser beam focal column of FIG. 11D spaced 200 μm along the length of the laser beam focal column of FIG. 11D from the cross section of FIG. 11E1, according to one or more embodiments shown and described herein;

FIG. 11E3 schematically depicts another cross section of the laser beam focal column of FIG. 11D spaced 200 μm along the length of the laser beam focal column of FIG. 11D from the cross section of FIG. 11E2, according to one or more embodiments shown and described herein;

FIG. 11E4 schematically depicts another cross section of the laser beam focal column of FIG. 11D spaced 200 μm along the length of the laser beam focal column of FIG. 11D from the cross section of FIG. 11E3, according to one or more embodiments shown and described herein;

FIG. 11E5 schematically depicts another cross section of the laser beam focal column of FIG. 11D spaced 200 μm along the length of the laser beam focal column of FIG. 11D from the cross section of FIG. 11E4, according to one or more embodiments shown and described herein; and

FIG. 11F schematically depicts another laser beam focal column, according to one or more embodiments shown and described herein.

### DETAILED DESCRIPTION

Reference will now be made in detail to embodiments of laser processing a transparent workpiece. In particular, embodiments described herein are directed to laser processing a transparent workpiece using laser beams formed and focused into laser beam focal columns to form a defect column in the transparent workpiece. The laser beam focal columns comprises a controllable radius of maximum beam intensity that is arbitrarily variable along the length of the laser beam focal column. Thus, the laser beam focal columns described herein may be used to create apertures, such as through substrate vias having correspondingly arbitrary radii throughout their depth.

The laser beam focal columns described herein may be formed using a modified Vortex beam that is non-diffracting and has a hollow-core, tube shaped focal region (i.e., laser beam focal column whose radius can be controlled along its length). The beam is formed using a high-powered, ultrafast laser, and then directed into a transparent workpiece. Due to its transparent nature, the low-intensity part of the beam (the portions outside the laser beam focal column or the portions in the hollow core of the laser beam focal column) can freely pass through the transparent workpiece with negligible absorption. In the laser beam focal column, however, high intensities will lead to significant nonlinear absorption which can damage the transparent workpiece to form a defect column. This high intensity region is a radius of maximum beam intensity, which may be referred to herein as the radius of the laser beam focal column. The damage that forms the defect column may comprise a densified material, microcracking, and void formation. The defect column is weak to both thermal stress and etching. The portion of the transparent workpiece bounded by the defect column may then be released from the transparent workpiece (e.g., dropped out) via etching or heating with a laser to cause thermal stresses. The end-result of this process will be an aperture in the transparent workpiece that has roughly the shape of the laser beam focal region.

The radius of maximum beam intensity of the laser beam focal column is variable along the length of the laser beam focal column and the radius of maximum beam intensity may be controlled along the length of the laser beam focal column by altering the optical elements used to form the laser beam focal column. These optical elements are part of a phase altering sub-assembly that may include one or more of a spatial light modulator, an axicon, a focusing lens (e.g., a convex lens, a concave lens, a plano-convex lens, a plano-concave lens), a vortex phase plate, a radial Airy phase plate, or any other phase plate. By varying the phase profile of these optics, different radially increasing or decreasing vortex beams can be created. Thus, the laser beam focal column having a variable radius of maximum intensity may be formed optically rather than from a mechanical system such as a stage or laser scan head. Indeed, the radius of maximum intensity may be arbitrarily varied along its length to form defect columns having arbitrarily variable shapes, such as an hourglass shape, a center bulging shape, a hollow column, a hollow cone, a hollow funnel, a curved funnel, and shapes that vary from hollow to non-hollow, which may be released to form arbitrarily variably shaped apertures. This allows rapid processing of even thick transparent workpieces as these shapes can be formed with a single ultrafast laser shot. Various embodiments of methods and apparatuses for processing a transparent workpiece will be described herein with specific reference to the appended drawings.

As used herein, “laser processing” comprises directing a laser beam onto and/or into a transparent workpiece. In some embodiments, laser processing further comprises translating the laser beam relative to the transparent workpiece, for example, along a contour line or other pathway. Examples of laser processing include using a laser beam to form one or more defects, such as defect columns, that extend into the transparent workpiece. Laser processing may form one or more apertures in a transparent workpiece.

As used herein, “upstream” and “downstream” refer to the relative position of two locations or components along a beam pathway with respect to a beam source. For example, a first component is upstream from a second component if the first component is closer to the beam source along the path traversed by the laser beam than the second component.

As used herein, “laser beam focal column,” refers to a pattern of interacting (e.g., crossing) light rays of a laser beam that forms a focal region elongated in the beam propagation direction and having an annular shape in a cross sectional direction orthogonal to the beam propagation direction. Furthermore, the laser beam focal column is “hollow” such that light rays of the laser beam have minimal to no interaction at an r₀ location of a cross section of the laser beam within the laser beam focal column. In conventional laser processing, a laser beam is tightly focused to a focal point. The focal point is the point of maximum intensity of the pulsed laser beam and is situated at a focal plane in the transparent workpiece. In the elongated focal region of a laser beam focal column, in contrast, the region of maximum intensity of the pulsed laser beam extends beyond the focal plane along an annular column aligned with the beam propagation direction.

As used herein, a “defect column” refers to a region of a transparent workpiece that has been modified by a laser beam. Defect columns include regions of a transparent workpiece having a modified refractive index relative to surrounding unmodified regions of the transparent workpiece. The defect column may include structurally modified regions such as void spaces, cracks, scratches, flaws, holes, perforations, densifications, or other deformities in the transparent workpiece produced by a laser beam focal column. A defect is formed through interaction of a laser beam focal column with the transparent workpiece. Due to the annular shape of the laser beam focal column, the defect columns described herein have a corresponding annular shape.

The phrase “transparent workpiece,” as used herein, means a workpiece formed from glass, glass-ceramic or other material which is transparent, where the term “transparent,” as used herein, means that the material has a linear optical absorption of less than 20% per mm of material depth, such as less than 10% per mm of material depth for the specified pulsed laser wavelength, or such as less than 1% per mm of material depth for the specified pulsed laser wavelength. Unless otherwise specified, the material has a linear optical absorption of less than about 20% per mm of material depth. The transparent workpiece may have a depth (e.g., thickness) of from about 50 microns (μm) to about 10 mm (such as from about 100 μm to about 5 mm, or from about 0.5 mm to about 3 mm). Transparent workpieces may comprise glass workpieces formed from glass compositions, such as borosilicate glass, soda-lime glass, aluminosilicate glass, alkali aluminosilicate, alkaline earth aluminosilicate glass, alkaline earth boro-aluminosilicate glass, fused silica, or crystalline materials such as sapphire, silicon, gallium arsenide, or combinations thereof. In some embodiments, the transparent workpiece may be strengthened via thermal tempering before or after laser processing the transparent workpiece. In some embodiments, the glass may be ion-exchangeable, such that the glass composition can undergo ion-exchange for glass strengthening before or after laser processing the transparent workpiece. For example, the transparent workpiece may comprise ion exchanged and ion exchangeable glass, such as Corning Gorilla® Glass available from Corning Incorporated of Corning, NY (e.g., code 2318, code 2319, and code 2320). Further, these ion-exchanged glasses may have coefficients of thermal expansion (CTE) of from about 6 ppm/° C. to about 10 ppm/° C. Other example transparent workpieces may comprise EAGLE XG® and CORNING LOTUS™ available from Corning Incorporated of Corning, NY. Moreover, the transparent workpiece may comprise other components, which are transparent to the wavelength of the laser, for example, glass ceramics or crystals such as sapphire or zinc selenide.

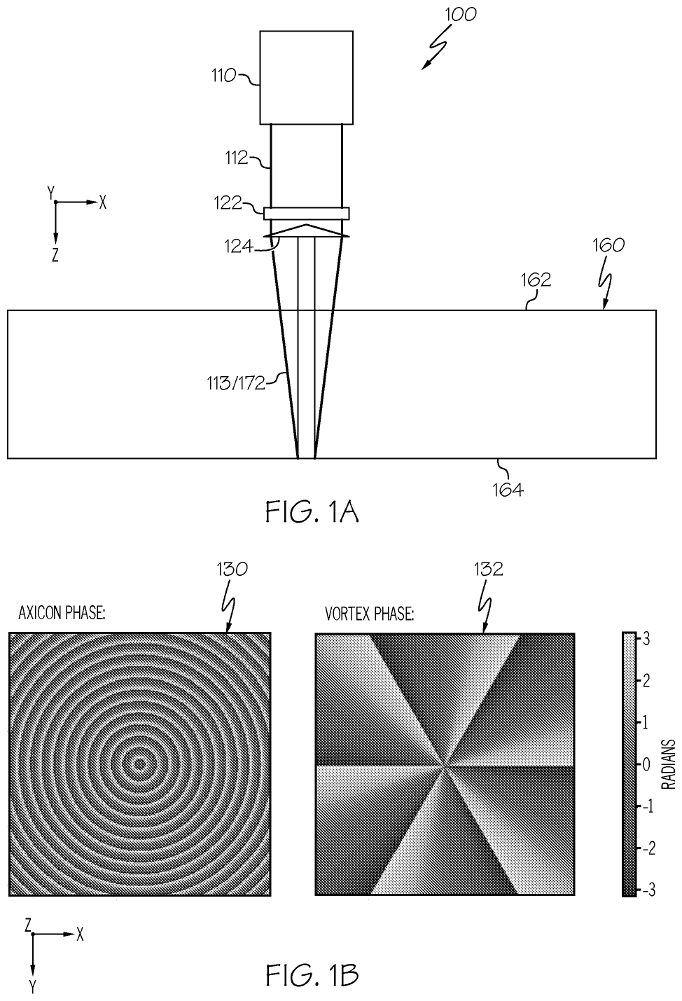

Referring now to FIGS. 1A-3B, an optical system 100 for forming a laser beam focal column 113 that is a Bessel-Vortex beam, phase masks for the optical system 100, and the laser beam focal column 113 are schematically depicted. The laser beam focal column 113 of FIGS. 1A-3B is formed by applying an axicon phase modification and a vortex phase modification (e.g., using an axicon phase mask 130 and a vortex phase mask 132 as shown in FIG. 1B) to the laser beam 112. The optical system 100 of FIG. 1A comprises a beam source 110 configured to generate a laser beam 112 and a phase altering sub-assembly 120 comprising a vortex phase plate 122 and an axicon 124. The vortex phase plate 122 applies the vortex phase modification to the laser beam 112, which is schematically depicted by the vortex phase mask 132 of FIG. 1B, and the axicon 124 applies the axicon phase modification to the laser beam 112, which is schematically depicted by the axicon phase mask 130 of FIG. 1B. The phase periods of each of the phase as shown in radians in a grayscale format. The axicon 124 and the vortex phase plate 122 are positioned in a beam pathway between the beam source 110 and a transparent workpiece 160, which comprises a first surface 162 opposite a second surface 164. In operation, propagating the laser beam 112, e.g., an incoming Gaussian beam, through the vortex phase plate 122 and the axicon 124 may alter, for example, phase alter, the laser beam 112 such that the portion of the laser beam 112 propagating beyond the phase altering sub-assembly 120 forms the laser beam focal column 113. Furthermore, in some embodiments, the phase altering sub-assembly 120 may include a spatial light modulator configured to apply the vortex phase modification and the axicon phase modification to the laser beam 112, in addition to or instead of the vortex phase plate 122 and the axicon 124.

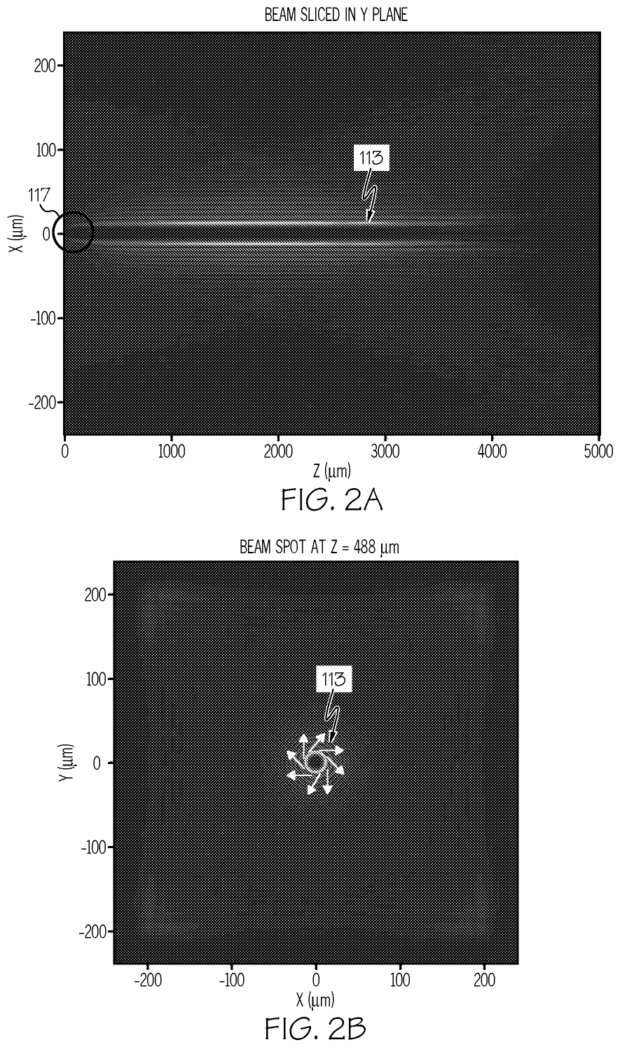

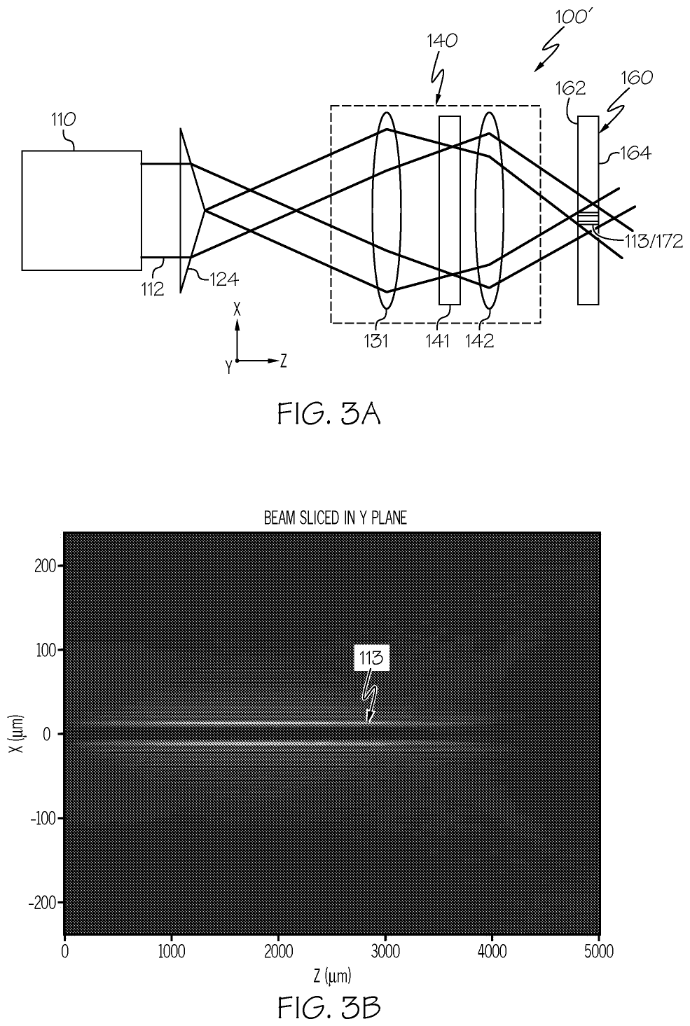

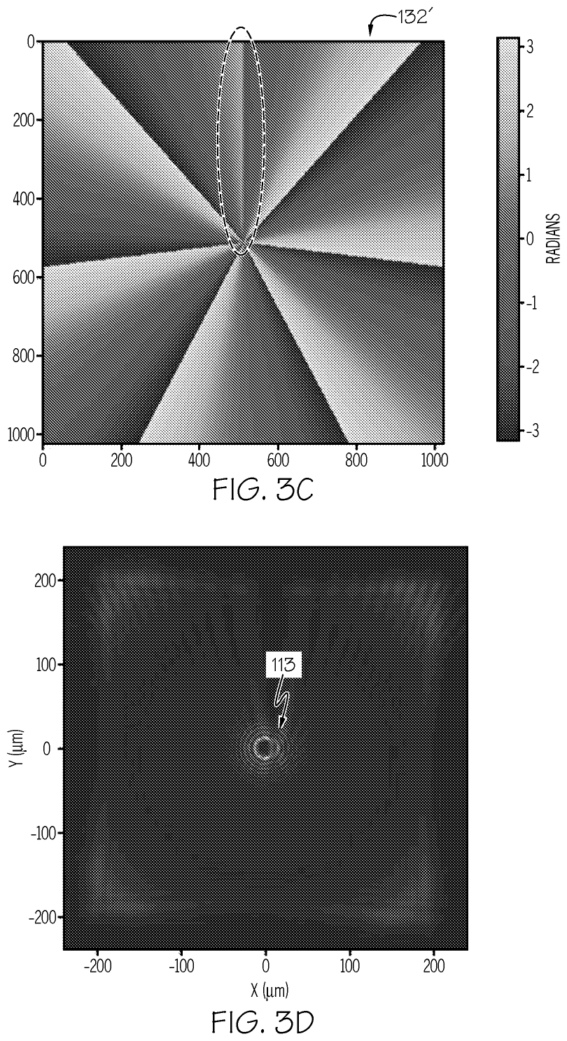

Referring now to FIGS. 2A and 2B, an example the laser beam focal column 113 is shown as a beam slice in the Y-plane (FIG. 2A) and as a beam spot at a location that is 488 μm along the length of the laser beam focal column 113. The example laser beam focal column 113 depicted in FIGS. 2A and 2B was formed using an vortex phase of m=6, a Gaussian beam with average beam waist w₀ of 500 μm, and an axicon angle of β=4°. As shown in FIG. 2A, the laser beam focal column 113 includes a transition region 117 near the start of the laser beam focal column 113 with an increasing radius of maximum beam intensity followed by a uniform radius of maximum beam intensity. To eliminate the transition region 117, the vortex phase plate 122 may be placed in a position in the optical system 100 in which the laser beam 112 has no rays or negligible rays at a radial position of r=0. In other words, at a position where the laser beam 112 is a hollow column. In the optical system 100′ of FIG. 3A, the vortex phase plate 122 is positioned between a first lens 141 and a second lens 142 of a lens assembly 140 (which may comprise a 4F lens assembly) in the Fourier space of the first lens 141. However, it should be understood that the vortex phase plate 122 may be positioned anywhere in the optical system 100′ in which the laser beam 112 impinges the vortex phase plate 122 is a hollow column. As shown in FIG. 3B, which is an example laser beam focal column 113 formed using the optical system 100′ of FIG. 3A, placing the vortex phase plate 122 in the Fourier space of the axicon 124 eliminates the transition region 117 and forms a uniform radius of maximum beam intensity along the length of the laser beam focal column 113.

Referring now to FIGS. 3C and 3D, and example discontinuous phase mask 132′ comprising a vortex phase of m=6.5 and an axicon angle of β=4° (FIG. 3C) that forms a laser beam focal column 113 (shown in cross section in FIG. 3D) with an average beam waist w₀ of 500 μm. FIG. 3D shows that when the vortex phase shift around a radial segment of the of a phase mask is a non-integer multiple of 2π, phase modification is applied to the laser beam 112 (here a non-integer multiple of 2π of m=6.5) an interference pattern that causes a discontinuity in the laser beam focal column 113 (circled in FIG. 3D) is created. Thus, while laser beam focal columns 113 may be formed by modifying the laser beam 112 any vortex phase shift, it may be desirable to form laser beam focal columns 113 by modifying the laser beam 112 using a vortex phase shift that is an integer multiple of 2π to minimize discontinuities.

Referring again to FIGS. 1A-3D, in operation, the defect column 172 may be formed in the transparent workpiece 160 by irradiating the transparent workpiece 160 with the laser beam 112 and in particular, directing the laser beam 112 into the transparent workpiece such that the laser beam focal column 113 is localized within the transparent workpiece 160. Directing or localizing the laser beam focal column 113 within the transparent workpiece 160 generates an induced absorption (e.g., MPA) within the transparent workpiece 160 and deposits enough energy to break chemical bonds in the transparent workpiece 160. MPA is the simultaneous absorption of two or more photons of identical or different frequencies that excites a molecule from one state (usually the ground state) to a higher energy electronic state (i.e., ionization). The energy difference between the involved lower and upper states of the molecule is equal to the sum of the energies of the involved photons. MPA, also called induced absorption, can be a second-order or third-order process (or higher order), for example, that is several orders of magnitude weaker than linear absorption. It differs from linear absorption in that the strength of second-order induced absorption may be proportional to the square of the light intensity, for example, and thus it is a nonlinear optical process.

In some embodiments, the beam source 110 may output a laser beam 112 comprising a wavelength of, for example, 1064 nm, 1030 nm, 532 nm, 530 nm, 355 nm, 343 nm, or 266 nm, or 215 nm. Further, the laser beam 112 used to the defect column 172 in the transparent workpiece 160 may be well suited for materials that are transparent to the selected pulsed laser wavelength. Suitable laser wavelengths for forming the defect column 172 are wavelengths at which the combined losses of linear absorption and scattering by the transparent workpiece 160 are sufficiently low. In embodiments, the combined losses due to linear absorption and scattering by the transparent workpiece 160 at the wavelength are less than 20%/mm, or less than 15%/mm, or less than 10%/mm, or less than 5%/mm, or less than 1%/mm, such as 0.5%/mm to 20%/mm, 1%/mm to 10%/mm, or 1%/mm to 5%/mm, for example, 1%/mm, 2.5%/mm, 5%/mm, 10%/mm, 15%/mm, or any range having any two of these values as endpoints, or any open-ended range having any of these values as a lower bound. As used herein, the dimension “/mm” means per millimeter of distance within the transparent workpiece 160 in the beam propagation direction of the laser beam 112 (i.e., the Z direction). Representative wavelengths for many glass workpieces include fundamental and harmonic wavelengths of Nd³⁺ (e.g. Nd³⁺:YAG or Nd³⁺:YVO₄ having fundamental wavelength near 1064 nm and higher order harmonic wavelengths near 532 nm, 355 nm, and 266 nm). Other wavelengths in the ultraviolet, visible, and infrared portions of the spectrum that satisfy the combined linear absorption and scattering loss requirement for a given substrate material can also be used.

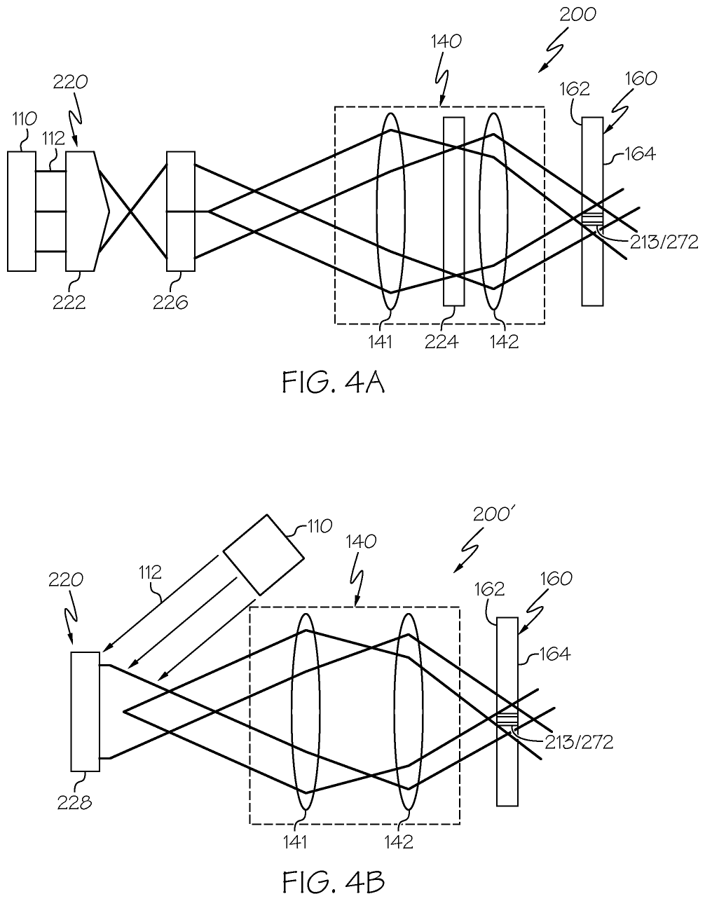

Referring now to FIGS. 4A and 4B, an optical system 200, 200′ is schematically depicted that includes an phase altering sub-assembly 220 that comprises one or more optical elements configured to apply an axicon phase and a vortex phase to the laser beam 112 (similar to the phase altering sub-assembly 120 of FIG. 1A) and apply a third phase modification to the laser beam 112. The third phase modification modifies the laser beam 112 such that the beam forms a laser beam focal column 213, which unlike the laser beam focal column 113, comprises an arbitrarily variable radius of maximum beam intensity, controlled by the application of the third phase modification. In addition, the phase altering sub-assembly 220 is configured to apply a third phase modification to the laser beam 112. The third phase modification is a radially symmetric phase modification and may comprise a continuous function or a non-continuous function. As one example, the third phase modification may comprise a focusing phase modification, such as a radially symmetric Airy phase modification. While not intending to be limited theory, the third phase modification is the phase modification responsible for altering the radius of the laser beam focal column 213 along its length.

In the optical system 200 of FIG. 4A, the one or more optical elements of the phase altering sub-assembly 220 comprise an axicon 222, a vortex phase plate 224, and a third optical element 226. The axicon 222 is configured to apply the axicon phase modification, the vortex phase plate 224 is configured to apply the vortex phase modification, and the third optical element 226 is configured to apply the third phase modification. In some embodiments, the third optical element 226 comprises a radial Airy phase plate and in other embodiments, the third optical element 226 comprises a lens, such as a focusing lens. A radial Airy phase plate can provide the additional phase changes needed to create an opening or closing laser beam focal column 213 (i.e., a laser beam focal column 213 that diverges or converges at each end). Indeed, if a radial Airy phase plate is used as the third optical element 226, then the resulting laser beam focal column 213 may comprise a radius that increases exponentially with length and if a lens is used as the third optical element 226, then the resulting laser beam focal column 213 may comprise a radius that increases at a steady rate with length. In the optical system 200′ of FIG. 4B, the one or more optical elements of the phase altering sub-assembly 220 comprise a spatial light modulator 228 that is configured to apply each of the axicon phase modification, the vortex phase modification, and the third phase modification.

While optical systems 200 and 200′ of FIGS. 4A and 4B comprise two example optical systems for applying the axicon phase modification, the vortex phase modification, and the third phase modification, it should be understood that any optical system configured to apply the axicon phase modification, the vortex phase modification, and the third phase modification is contemplated. For example, in the optical system 200 of FIG. 4A, the third phase modification may be applied by a modified version of the axicon 222 instead of the third optical element 226. In other words, a modified version of the axicon 222 may be used which both applies the axicon phase modification and the third phase modification to the laser beam 112. Indeed, embodiments are contemplated in which a single physical optical element that is refractive or diffractive is used to apply one, two, or all three of the vortex phase modification, the axicon phase modification and the third phase modification to the laser beam 112. As another example, an optical system is contemplated in which a spatial light modulator 228 is used in combination with one or both of the axicon 222 and the vortex phase plate 224. In these embodiments, the spatial light modulator 228 may apply the third phase modification and may also apply one of the vortex phase modification and the axicon phase modification. Moreover, embodiments are contemplated comprising multiple spatial light modulators, which may be used with or without additional phase modifying optical elements, such as the vortex phase plate 224 and the axicon 222.

Without intending to be limited by theory, the combination of the axicon phase modification, the vortex phase modification, and the third phase modification generates the laser beam focal column 213. In particular, the third phase modification applies selective variability to the radius of the laser beam focal column 213 along the length of the laser beam focal column 213. Without intending to be limited by theory, changing axicon angle β, vortex phase m, and the beam waist w₀ can influence the radius and length of the laser beam focal column 213, while varying the lens radius of curvature or the coefficient of the radial Airy phase plate (i.e., varying the third phase modification) of the third optical element 226 can influence the rate of change of the radius of maximum beam intensity of the laser beam focal column 213.

In some embodiments, the laser beam focal column 213 comprises a radius of maximum beam intensity that is variable along a length of the laser beam focal column 213 such that the radius of maximum beam intensity comprises at least two non-zero angles of propagation with respect to a centerline of the laser beam focal column along the length of the laser beam focal column. In some embodiments, the laser beam focal column 213 comprises a radius of maximum beam intensity that comprises a non-monotonic variability along the length of the laser beam focal column 213. The variability of the radius of maximum intensity of the laser beam focal column 213 facilitates the formation of laser beam focal columns 213 having a variety of shapes and sizes, such as an hourglass shape, a center bulging shape, a hollow column, a hollow cone, a hollow funnel, a curved funnel, and shapes that vary from hollow to non-hollow, which may be released to form arbitrarily variably shaped apertures. The laser beam focal column 213 may have a length in a range of from about 0.1 mm to about 100 mm or in a range of from about 0.1 mm to about 10 mm. Various embodiments may be configured to have a laser beam focal column 213 with a length 1 of about 0.1 mm, about 0.2 mm, about 0.3 mm, about 0.4 mm, about 0.5 mm, about 0.7 mm, about 1 mm, about 2 mm, about 3 mm, about 4 mm, or about 5 mm e.g., from about 0.5 mm to about 5 mm.

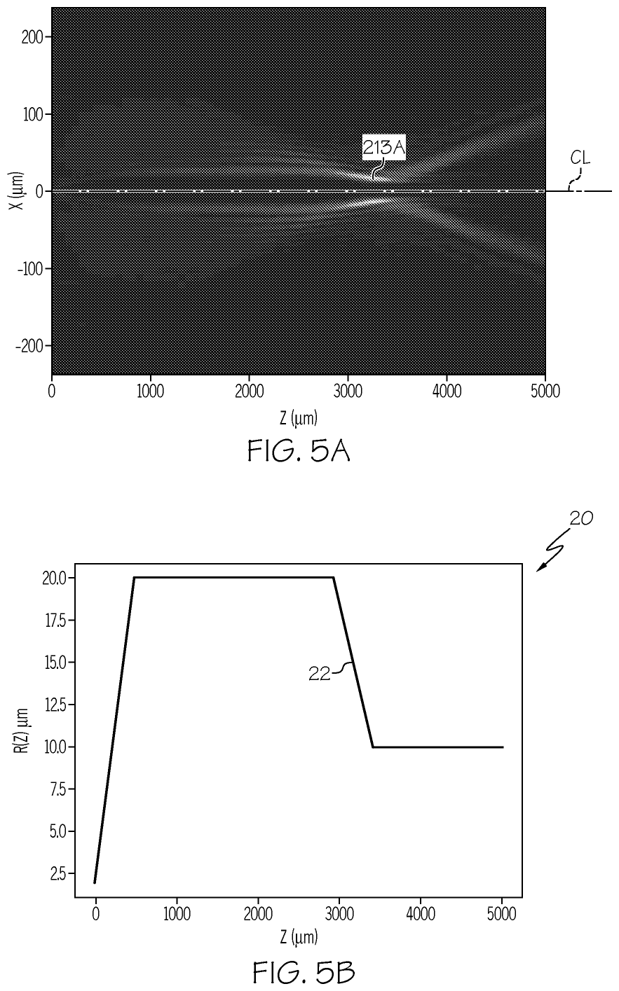

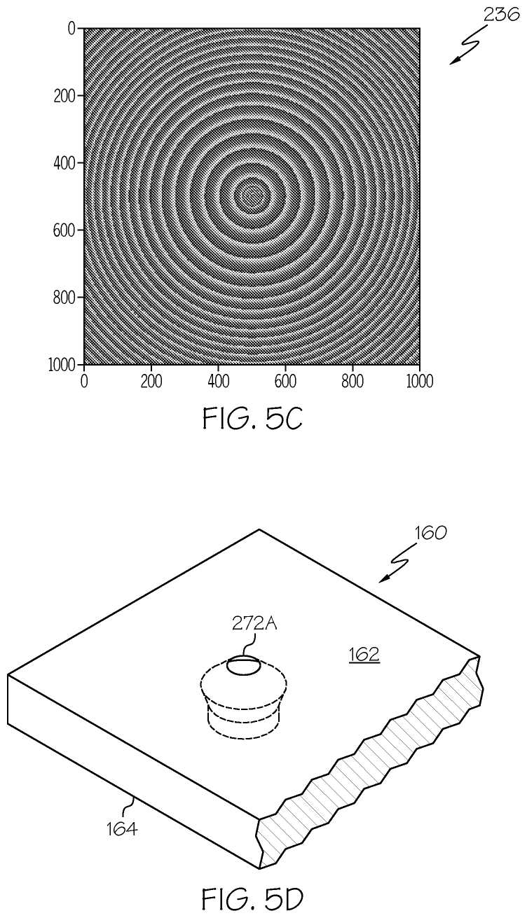

Referring now to FIG. 5A, an example laser beam focal column 213A that may be formed using one of the optical systems 100, 100′ is schematically depicted. The laser beam focal column 213A comprises a radius of maximum beam intensity that both increases and decreases at different locations along the length of the laser beam focal column 213A. Indeed, the laser beam focal column 213A has at least two non-zero angles of propagation with respect to a centerline CL of the laser beam focal column 213A. This is graphically shown in graph 20 of FIG. 5B, in which line 22 shows the radius of maximum beam intensity as a function of position along the length of the laser beam focal column 213A (i.e., along the Z axis). Line 22 shows that the laser beam focal column 213A has a region of increasing radius of maximum beam intensity (corresponding with a non-zero angle of beam propagation with respect to the centerline CL of the laser beam focal column 213A), a region of decreasing radius of maximum beam intensity (corresponding with another non-zero angle of beam propagation), and multiple regions of uniform radius of maximum beam intensity (corresponding with a zero angle of beam propagation with respect the centerline CL of the laser beam focal column 213A). As the radius of maximum intensity of the laser beam focal column 213A both increases and decreases along the length of the laser beam focal column 213A, the radius of maximum beam intensity is non-monotonic along the length of the laser beam focal column 213A.

Furthermore, FIG. 5C depicts a focusing phase mask 236 that may be applied to the laser beam 112 by the third optical element 226 to add a third phase modification to the laser beam 112 (in addition with the vortex phase modification applied by the vortex phase plate 224 and the axicon phase modification applied by the axicon 222) to form the laser beam focal column 213A of FIG. 5A. Moreover, FIG. 5D, shows a schematic depiction of a defect column 272A formed in the transparent workpiece 160 using the laser beam focal column 213A. The defect column 272A comprises a variable radius from the first surface 162 to the second surface 164 of the transparent workpiece 160 corresponding with the variable radius of maximum intensity of the laser beam focal column 213A used to form the defect column 272A.

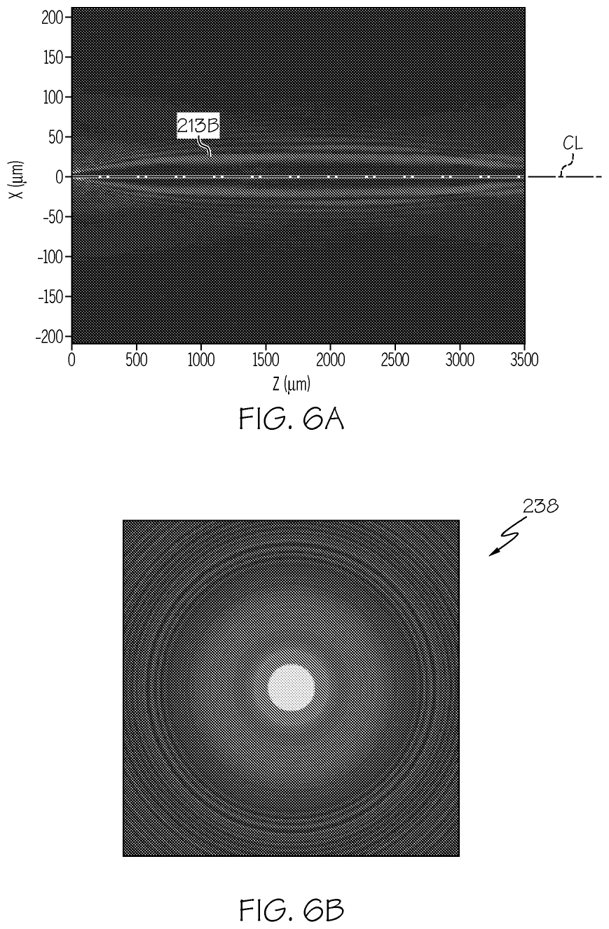

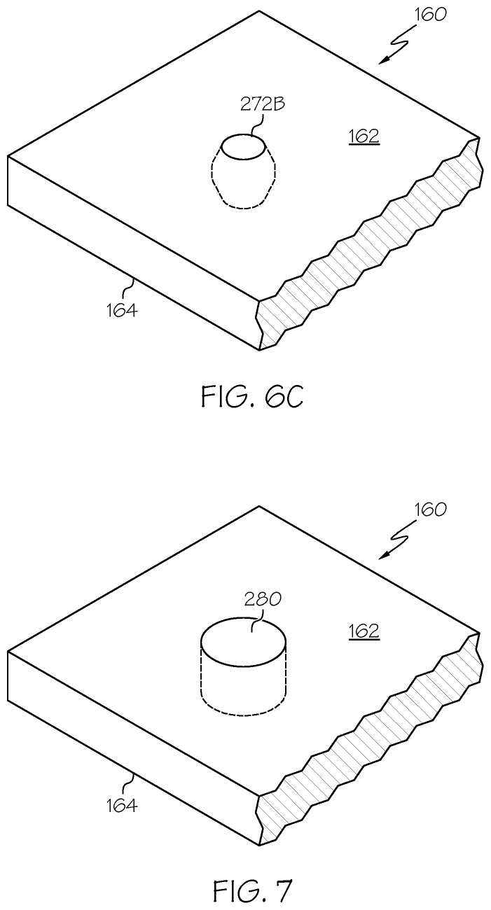

Referring now to FIG. 6A, another example laser beam focal column 213 is schematically depicted. The laser beam focal column 213B of FIG. 6A comprises a radius of maximum beam intensity that both increases and decreases at different locations along the length of the laser beam focal column 213B. The laser beam focal column 213B also has at least two non-zero angles of propagation with respect to a centerline CL of the laser beam focal column 213B. In particular, the laser beam focal column 213B comprises a reverse hourglass shape, in which the radius of maximum beam intensity is variable along a length of the laser beam focal column, tapering at a divergent angle with respect to the centerline CL at a first end of the laser beam focal column 213B (e.g., the Z=0 end) and tapering at a convergent angle with respect to the centerline CL at a second end of the laser beam focal column 213B, opposite the first end.

Referring now to FIG. 6B, an amplitude mask 238 for the formation of the laser beam focal column 213B is depicted. The amplitude mask 238 is a hybrid mask that may be implemented by the spatial light modulator 228 to apply each of the vortex phase modification, the axicon phase modification, and the third phase modification to the laser beam 112 to thereby form the laser beam focal column 213B of FIG. 6B. Moreover, the amplitude mask 238 is also designed such that the resultant laser beam focal column 213B comprises a uniform maximum intensity (i.e., a uniform maximum intensity in the radius of maximum intensity) along the length of the laser beam focal column 213B.

Without intending to be limited by theory, beam intensity is affected by both the magnitude of the axicon angle β and the change in radius at a local position along the length of the laser beam focal column 213B. Although each radial position r on a focusing element (such as the third optical element 226 in optical system 100 of FIG. 4A) corresponds to a specific focal distance Z, in reality each r affects a range in Z. This means that the intensity of the laser beam focal column 213 at a Z location depends not only on the beam intensity at the corresponding r of the focusing element, but also on the intensities in neighboring locations. Because expanding the radius of the laser beam focal column 213 means that Z is associated with a quickly increasing r, expanding portions of the laser beam focal column 213 will be spread out, resulting in less overlap between adjacent portions of the beam and a lower intensity. Conversely, a decreasing beam radius in the laser beam focal column 213 results in increased overlap and a higher intensity.

To achieve the laser beam focal column 213B of FIG. 6A, which comprises a uniform maximum intensity along a variable radius of maximum intensity, the amplitude mask 238 mimics a variable intensity beam spot impinging a focusing lens, where this variable intensity beam spot comprises a greater intensity at local regions which correspond to expanding (i.e., diverging) portions of the resultant laser beam focal column 213B and this variable intensity beam spot comprises a lesser intensity at local regions which correspond to contracting (i.e., converging) portions of the resultant laser beam focal column 213B. While the amplitude mask 238 may be applied to the laser beam 112 by the single spatial light modulator 228 of the optical system 200 of FIG. 4A, some embodiments may include multiple spatial light modulators or a combination of a spatial light modulator and a phase to reduce loss in the optical system. While not intending to be limited by theory, achieving simultaneous control over beam phase and amplitude using a single spatial light modulator may result in localized efficiency reduction of portions of the single spatial light modulator, which may be reduced by using two or more spatial light modulators or multiple passes through different portions (e.g., different phase mask portions) of the single phase modulator.

Referring now to FIG. 6C, a defect column 272B formed by directing the laser beam focal column 213B into the transparent workpiece 160 is schematically depicted. The defect column 272B comprises a variable radius from the first surface 162 to the second surface 164 of the transparent workpiece 160 corresponding with the variable radius of maximum intensity of the laser beam focal column 213B used to form the defect column 272B. Moreover, as the laser beam focal column 213B comprises uniform intensity along the variable radius of maximum intensity, the damage in the transparent workpiece 160 that forms the defect column 272B is similarly uniform.

Referring now to FIGS. 5A-7, after forming the defect column 272 (e.g., 272A, 272B) in the transparent workpiece 160, the transparent workpiece 160 may be further acted upon in a subsequent release step to induce release of the material of the transparent workpiece 160 bounded by the defect column 272 thereby forming an aperture 280 (FIG. 7). The subsequent separating step includes directing applying thermal stress or chemical etching to the defect column 172 to release the material of the transparent workpiece 160 and form an aperture 180 extending through the transparent workpiece 160. One advantage of forming defect columns 272 using the laser beam focal column 213 having a variable radius is that their shape allows for the undamaged core of the aperture 280 to dropout more easily than a defect column with straight damage formed be a uniform radius hollow beam, particularly when separating the defect column 172 from the remainder of the transparent workpiece 160 using chemical etching.

Thermal stress may be applied by impinging the defect column 272 with an infrared laser beam, which is a controlled heat source that rapidly increases the temperature of the transparent workpiece 160 along the defect column 272. This rapid heating may build compressive stress in the transparent workpiece 160 on or adjacent to the defect column 272. Since the area of the heated glass surface is relatively small when compared to the overall surface area of the transparent workpiece 160, the heated area cools relatively rapidly. The resultant temperature gradient induces tensile stress in the transparent workpiece 160 sufficient to propagate a crack along the defect column 272 and through the depth of the transparent workpiece 160, resulting in full separation of the material bounded by the defect column 272 of the transparent workpiece 160 from the remainder of the transparent workpiece 160, thereby forming the aperture 280. Without being bound by theory, it is believed that the tensile stress may be caused by expansion of the glass (i.e., changed density) in portions of the workpiece with higher local temperature. Example infrared laser beams include a carbon dioxide laser (a “CO₂ laser”), a carbon monoxide laser (a “CO laser”), a solid-state laser, a laser diode, or combinations thereof.

Alternatively, the defect column 272 may be chemically etched to separate the portion of the transparent workpiece 160 bounded by the defect column 272. For example, the transparent workpiece 160 may be chemically etched by applying a chemical etching solution comprising a chemical etchant to the transparent workpiece 160, at least on the defect column 272. The chemical etching solution may be an aqueous or vapor solution that includes the chemical etchant and deionized water. Example chemical etchants include hydrofluoric acid, nitric acid, sulfuric acid, potassium hydroxide, sodium hydroxide, and combinations thereof.

Because the laser beam focal column 213 may comprise an arbitrarily variable radius, the laser beam focal column 213 may be used to overcome some of the shortcomings of chemically etching transparent workpieces 160, in particular, the difficulty of uniformly removing material through the depth of the transparent workpiece 160 caused by the time it takes for a chemical etching penetrate into the depth of the transparent workpiece 160. When chemically etching a defect column with a uniform radius along its length, the resultant aperture forms an hourglass shaped profile in which a radius of the aperture at the first and second surfaces 162, 164 of the transparent workpiece 160 is greater than a waist radius within the depth of the aperture (e.g., about halfway between the first and second surfaces 162, 164). This hourglass shaped profile is caused by the initial restriction of the chemical etching solution traversing the depth of the defect column (i.e., diffusing through the depth of the defect column 272). Thus, the portions of the defect column at and near the first and second surfaces 162, 164 will immediately undergo etching when the chemical etching solution contacts the transparent workpiece 160; while portions of the defect column within the transparent workpiece 160 will not undergo etching until the chemical etching solution diffuses through the depth of the defect column (i.e., diffuses from each of the first and second surfaces 162, 164 to the waist of the defect column).

However, this may be overcome by forming the defect column 272B having a reverse hourglass shape, formed by impinging the transparent workpiece 160 with the laser beam focal column 213B having a radius of maximum beam intensity which is variable along a length of the laser beam focal column 213B, tapering at a divergent angle at the first surface 162 and tapering at a convergent angle approaching the second surface 164 from the bulk of the transparent workpiece 160. In other words, the laser beam focal column 213B and the resultant defect column 272B comprises tapered end sections. Thus, the defect column 272B has the same reverse hourglass shape as the laser beam focal column 213B. When the defect column 272B is etched, more material is removed at near the first surface 162 and the second surface 164 than in the center of the transparent workpiece 160 resulting in a more uniform aperture. For example, when the laser beam focal column 213B is removed via chemical etching, the resulting aperture 280 (FIG. 7) may comprise an aperture radius that varies by 10% or less along a length of the aperture 280 (i.e., from the first surface 162 to the second surface 164), for example 5% or less variation, 2% or less variation, 1% or less variation, or even 0% variation. Furthermore, the aperture 280 may comprise an aperture radius (i.e., an average aperture radius in embodiments with greater than 0% variation) of from 4 μm to 60 μm, such as from 5 μm to 50 μm, 10 μm to 50 μm, or the like.

As noted above, to form the laser beam focal column 213, the laser beam 112, which may comprise a Gaussian laser beam, is passed through the vortex phase plate 224, the axicon 222, and the third optical element 226 which applies the focusing modification. Alternatively, the laser beam impinges a single phase-altering element (e.g., the spatial light modulator 228) which applies each of the vortex phase modification, the axicon phase modification, and the third optical component. A mathematical discussion of the formation of the laser beam focal column 213 will now be presented with respect to the vortex phase plate 224, the axicon 222, and the third optical element 226, although it should be understood that the functionality of each optical element may be collectively disposed in the spatial light modulator 228. The initial Gaussian beam (e.g., the laser beam 112) comprises a Gaussian envelope (in radial coordinates):

$${𝒰}_{gauss} = {e}^{\frac{{r}^{2}}{{w}_{0}^{2}}} * {e}^{- ip} \qquad ( 1 )$$

where r is the radial coordinate (assumed to be 0 in the center of the beam), w₀ is the radius at which the beam intensity falls to 1/e² times its maximum intensity, and p is the phase of the beam, which will be equal to a constant for a Gaussian beam (the constant chosen in this case will be 0).

Next, the phase of the vortex phase plate 224 is:

Pᵥₒᵣₜₑₓ=∅m (2)

where φ is the azimuthal angle and m is the order of the vortex phase of the vortex phase plate 224, and the phase of an axicon 222 is:

Pfe=−k₀_{^{r}} sin(β) (3)

where β is the half-cone angle of the light exiting the axicon 222. The two phases may be added so that the full Bessel-Vortex beam, which is the beam used to form the laser beam focal column 113 of FIG. 1A-3B has the following equation:

$$u = {e}^{\frac{{r}^{2}}{{w}_{0}^{2}}} * {e}^{i ( ϕ m + {k}_{0} rsin ( β ) )} \qquad ( 4 )$$

The radius at the focal spot (the minimum radius achieved by the full Bessel-Vortex beam) will depend on both the tightness of focusing from the axicon 222 and the magnitude of the azimuthal charge imparted by the vortex phase plate 224. To find this radius, the initial direction of the light exiting the vortex phase plate 224 is found by taking the gradient of the phase due to each component:

$${k}_{vortex} = {\partial }_{ϕ} \frac{{P}_{vortex}}{r} = \frac{m}{r} \qquad ( 5 )$$

Next the analysis is converted to Cartesian coordinates to follow an example ray being emitted from a point (r₀, φ=0, z=0) in cylindrical coordinates or (x=r, y=0, z=0) in Cartesian coordinates. It follows from the definitions ∂φ and ∂r that the directional unit vector of this ray will have a component in the x-direction from equation (6) and one in the y-direction from equation (5). The unit vector of this ray will then be (after dividing by k):

$$[ \hat{x} , \hat{y} , \hat{z} ] = [ - sin ( β ) , \frac{m}{{kr}_{0}} , \sqrt{1 - {\hat{x}}^{2} - {\hat{y}}^{2}} ] \qquad ( 7 )$$

For simplicity, a position vector as a function of Z is then found by:

$$P ( z , {r}_{0} ) = [ {P}_{x} , {P}_{y} , {P}_{z} ] = [ \frac{- z sin ( β )}{{Z}_{f}} + {r}_{0} , \frac{mz}{{kr}_{0} {Z}_{f}} , z ] \qquad ( 8 )$$

Where

$${Z}_{f} = \sqrt{1 - {sin}^{2} ( β ) - {( \frac{m}{{kr}_{0}} )}^{2}} = \sqrt{{cos}^{2} ( β ) - {( \frac{m}{{kr}_{0}} )}^{2}} \qquad ( 9 )$$

Then, its radius can be expressed as:

$$R ( z , {r}_{0} ) = \sqrt{{P}_{x}^{2} ++ {P}_{y}^{2}} = {\sqrt{{( - z sin ( β ) + {r}_{0} )}^{2} + ( \frac{mz}{{kr}_{0}} )}}^{2} \qquad ( 10 )$$

Now, to find the point of minimum radius, the derivative is set with respect to z equal to 0 (and drop the square root) and solve for z:

$${z}_{min} = \frac{{Z}_{f} {k}^{2} {r}_{0}^{3} sin ( β )}{( {k}^{2} {r}_{0}^{2} {sin}^{2} ( β ) + {m}^{2} )} \qquad ( 11 )$$

The waist radius is a function of z as well as m and β. This is due to the transition region 117 that can be seen in FIG. 2A. After reducing the transition region 117 by positioning the vortex phase plate 224 in the Fourier space of the axicon 222 (as shown in both FIGS. 1A and 4A), the next step is to control the final radius of the beam (i.e., the radius of maximum beam intensity of the laser beam focal column 213). Therefore, we substitute zₘᵢₙ into equation 10, and then take the limit as r₀ goes to infinity to find an expression for waist radius:

$${R}_{∞} ( m , β ) = {lim}_{{r}_{0} \to ∞} R ( {z}_{min} , {r}_{0} ) = \vert \frac{m}{k sin ( β )} \vert \qquad ( 12 )$$

Assuming a constant k, the waist radius is predictable via the vortex plate order m and the axicon angle β. To create a vortex beam with a desired radius of maximum intensity R(z) at each z position on the focusing axis, we can solve Equation 12 with constant m, constant β, or vary both. It was found through experimentation that varying β with a constant m yields the best results because non-integer m's do not wrap correctly around φ. This requires discontinuities in pᵥₒᵣₜₑₓ for non-integer m's which result in interference patterns in the resulting beam (as shown in FIG. 4B). Note that this can be partially alleviated by wrapping the phase function pᵥₒᵣₜₑₓ to less than 2π, but when m is varied rapidly this still leads to undesired interference patterns in the focus. To find the sin(β) required to form a vortex beam with R_{infinity}=R(z), Equation 12 can be solved for sin(β). Sin(β) is chosen here instead of β because sin(β) is equivalent to the slope of the phase p_{axicon}.

$$sin ( β ) = \frac{dh}{dr} = \vert \frac{m}{kR ( z )} \vert \qquad ( 13 )$$

where h is the focusing element height. Here, cylindrical coordinates are used and the focusing element (i.e., the third optical element) is assumed to be rotationally symmetric. In order to create a phase mask p_{fe}(r), all that remains is to relate the propagation variable z to the radial coordinate r, to determine what region of the phase mask each dh/dr must fill. This is done by substituting r in for r₀ in Equation 11 and then into Equation 13, giving:

$$\frac{dh}{dr} = \frac{\vert m \vert}{k ℛ ( \frac{{Z}_{f} {k}^{2} {r}^{3} \frac{dh}{dr}}{{k}^{2} {{r}^{2} ( \frac{dh}{dr} )}^{2} + {m}^{2}} )} \qquad ( 14 )$$

Noting that the absolute value was moved to m because k and R(z) are assumed to be positive. The resulting equation must then be solved for dh/dr, by subtracting from both sides and finding the root numerically. A height map for the focusing element (e.g., the third optical element), which can then be turned into a phase mask can then be created by starting from r=0 in the center of the element, and moving outward adding dh/dr*dr to the height at each step. Note that the dh/dr found from Equation 14 can encounter edge effects near the end of the beam due to the numerical solver if R_{inf} isn't a function. By writing an R_{inf} that extends beyond the desired beam length and truncating the resulting height map, the edge effects may be overcome. Furthermore, the length of the laser beam focal column can be controlled by changing the m and w₀ of the beam. Phases found with this method can be imparted onto a Gaussian laser beam in the form of a diffractive optic, spatial light modulator, or refractive optic. In the case of a refractive optic, the height h can be used directly; otherwise, the phase can be found by inserting h into a phase equation:

Pfe=−k₀h (15)

U_{fe}=e^{ip}^{_{fe}} (16)

arg(u_{fe}) can then be written to a spatial light modulator which may be used to form a laser beam focal column with an arbitrarily variable radius.

In view of the foregoing description, it should be understood that laser beams may be formed and focused into laser beam focal columns to form a defect column in the transparent workpiece. In particular, the laser beam focal columns comprises a controllable radius of maximum beam intensity that is arbitrarily variable along the length of the laser beam focal column, which may be used to form arbitrarily variable defect columns which in turn may be separated from the transparent workpiece to form apertures with a variety of shapes.

### EXAMPLES

### Example 1

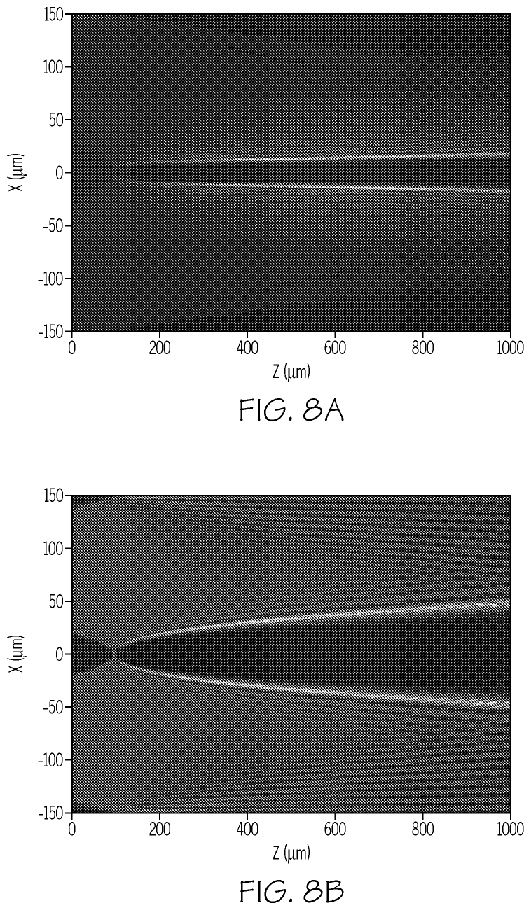

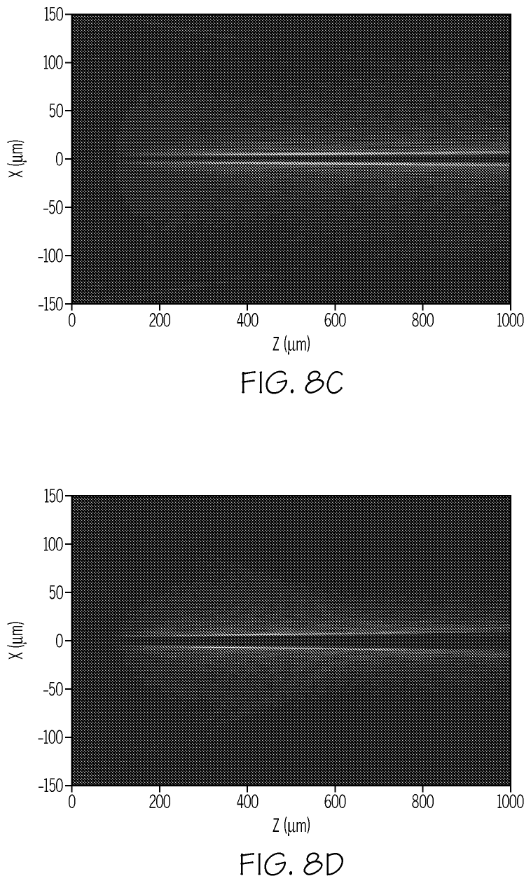

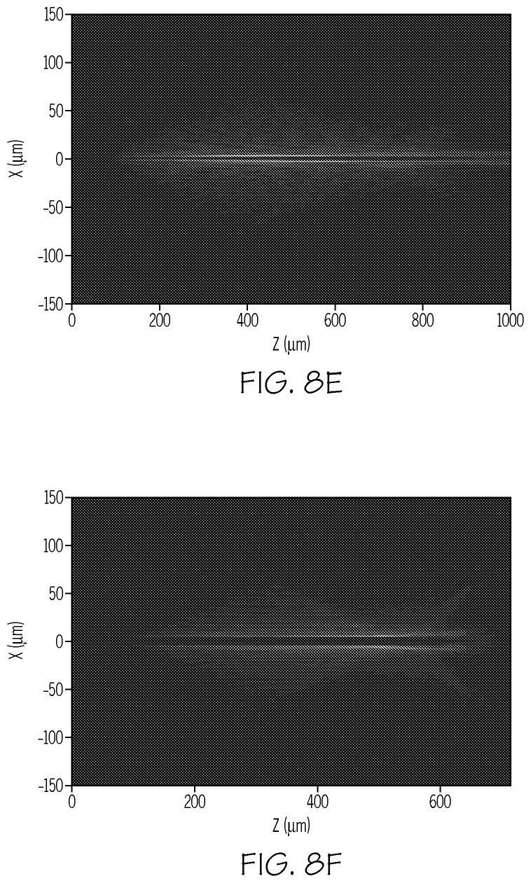

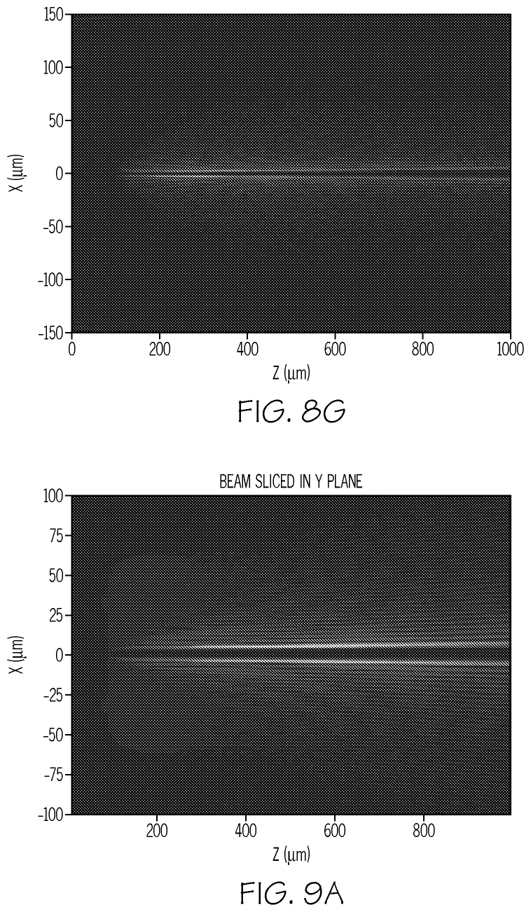

Example 1 is an example laser beam focal column, depicted in FIG. 8A, which is modifiable using a variety of optical elements that apply phase modifications to form any of the laser beam focal columns depicted FIGS. 8B-8E. In FIG. 8A, the example laser beam focal column is propagating from left to right and is formed by applying a vortex order m=15 (e.g., using a vortex phase plate of a spatial light modulator) and applying β=10°. In FIG. 8B, the laser beam focal column is formed using a lower axicon angle and thus the radius of the laser beam as it propagates on its focal plane (around Z=80 μm in FIGS. 8A and 8B) when compared to FIG. 8B. In FIG. 8C, the laser beam focal column is formed by applying a lower vortex order m than is applied in FIG. 8A, which reduces the initial and final radii of the beam along the z-axis while keeping a similar angle of propagation as FIG. 8A. In FIG. 8D, the laser beam focal column has a higher axicon angle β than FIG. 8A, which steepens the angle of propagation with respect to the Z-axis in comparison to FIG. 8A. In FIG. 8E, the laser beam focal column is formed using a higher axicon angle β than FIG. 8C and a lower vortex order m than FIG. 8D. The combination of these effects results in a laser beam focal column that is smaller in radius than FIG. 8D, but steeper in angle than FIG. 8C. Indeed. FIG. 8C depicts that multiple variables to be used at once to create a laser beam focal column having a particular curve and shape.

### Example 2

Example 2 is an example laser beam focal column formed both without a radially symmetric Airy phase modification (FIG. 8F) and with a radially symmetric Airy phase modification (FIG. 8G). Because the laser beam focal column of FIG. 8F does not have a radial Airy phase modification (e.g., it has its Airy coefficient (Ac) removed), the laser beam focal column does not propagate as long as the laser beam focal column of FIG. 8F. Moreover, because of the lack of curvature from the radially symmetric Airy phase modification, the laser beam focal column of FIG. 8F is more collimated than the laser beam focal column of FIG. 8G. Indeed, the increased Airy coefficient of the laser beam focal column of FIG. 8G can be used to open up the ending radius (e.g., the radius of the laser beam focal column as it approached Z=1000 μm) either in a linear or curving manner.

### Example 3

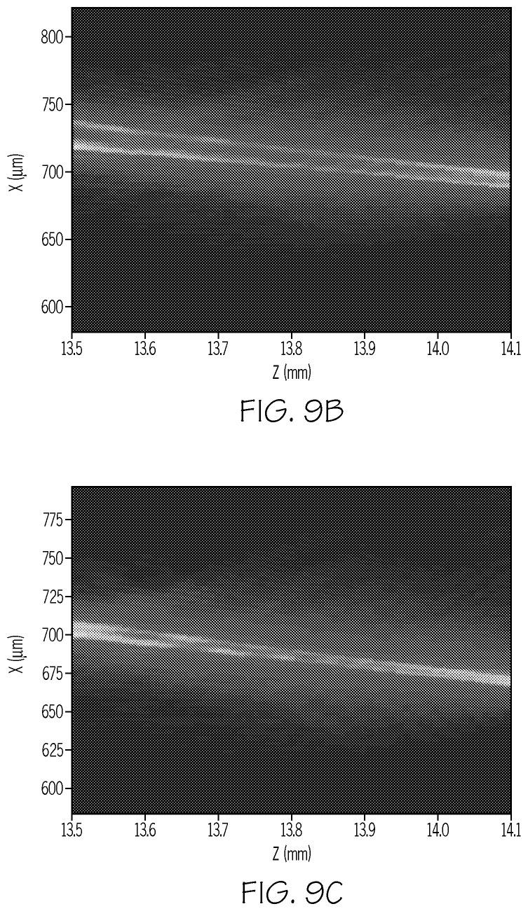

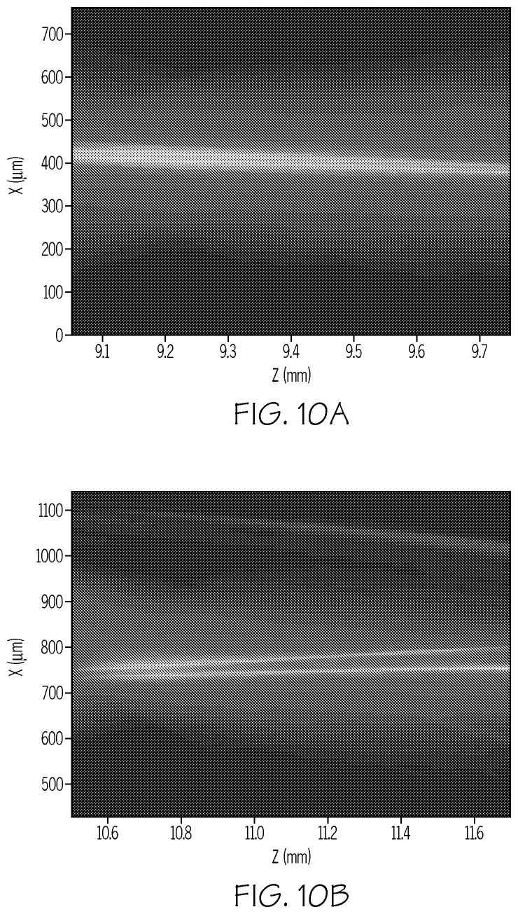

Example 3 is an example laser beam focal column formed using the variables of Ac=−2e⁶, m=5, H=10 and w₀=500, which H is the axicon height. A simulated version of this laser beam focal column is shown in FIG. 9A and experimental images of this laser beam focal column are shown in FIGS. 9B and 9C. In FIG. 9B, the laser beam focal column is formed using a spatial light modulator to apply the above variables and is propagating from left to right. The laser beam focal column is imaged using a camera with a long depth of focus, which results in them being integrated in the Y direction (i.e., into the page). This results in the laser beam focal column not appearing “hollow” since the light from the sidewall can be seen. In FIG. 9C, the laser beam focal column is formed using a spatial light modulator to apply the above variables and is propagating from right to left. Similar, to FIG. 9B, the laser beam focal column in FIG. 9C is imaged using a camera with a long depth of focus, which results in them being integrated in the Y direction (i.e., into the page). By propagating the beam from right to left, the laser beam focal column of FIG. 9C demonstrates the effect of changing the vortex order in the beam equation.

### Example 4

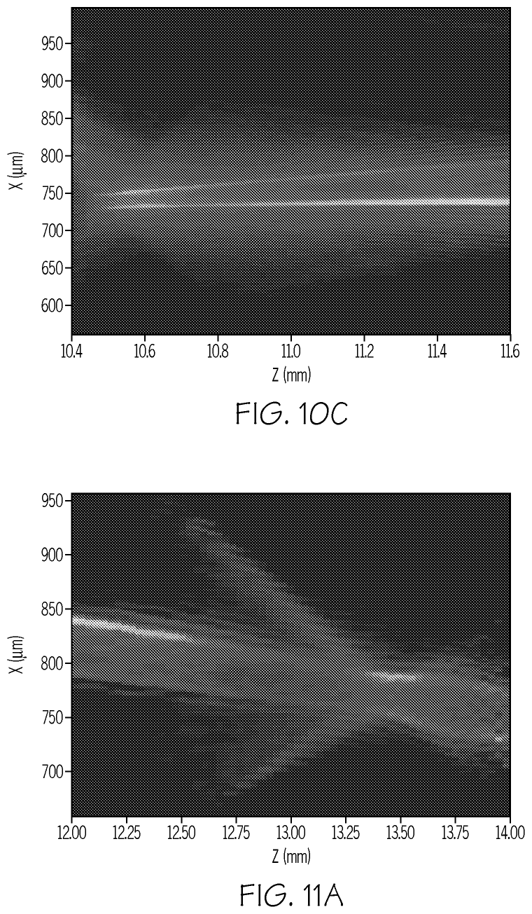

Example 4 is depicts the effect of applying the third phase modification to example Bessel-Vortex laser beam focal column (such as the laser beam focal column 113 of FIGS. 1A and 3A) formed by applying an axicon phase modification and a vortex phase modification. FIG. 10A is an experimental image of a Bessel-Vortex laser beam focal column without the third phase modification (formed using an axicon and a vortex phase plate). FIG. 10B is an experimental image of another laser beam focal column formed in the same manner as FIG. 10A with the addition of a 35 mm lens positioned to focus into the axicon to apply the third (focusing) phase modification. FIG. 10C is an experimental image of another laser beam focal column formed in the same manner as FIG. 10A with the addition of a 25 mm lens positioned to focus into the axicon to apply the third (focusing) phase modification. FIGS. 10B and 10C show that the additional focusing provided by the higher angle with the 25 mm lens as compared to the 35 mm lens. The higher angle increases the angle that the radius increases (i.e., increases the angle of propagation with response to a centerline of the laser beam focal column).

### Example 5

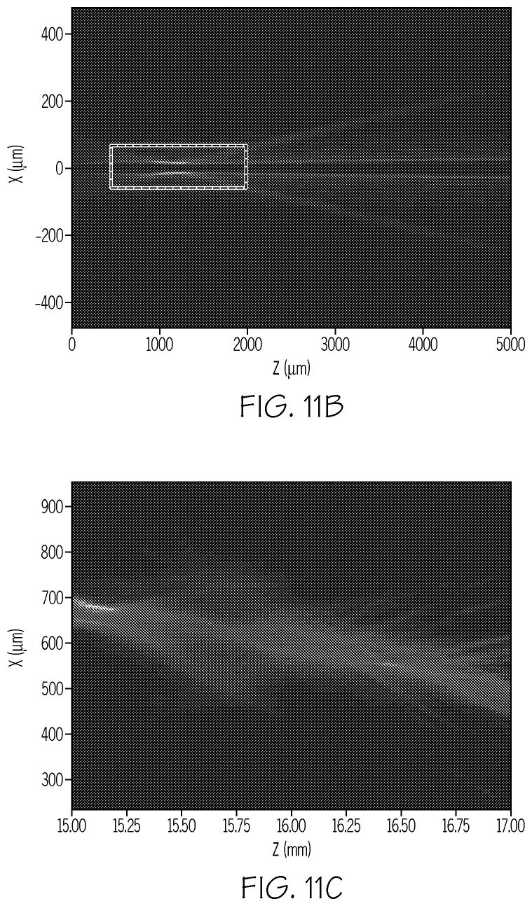

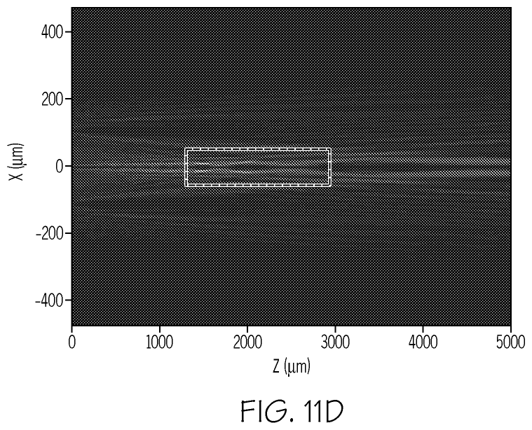

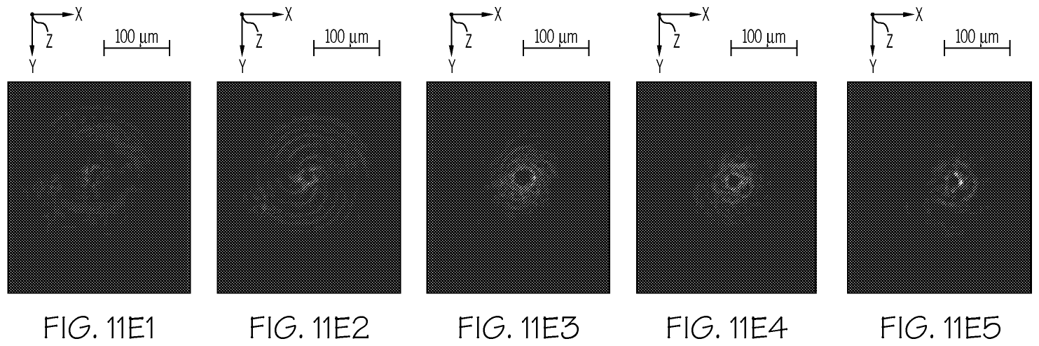

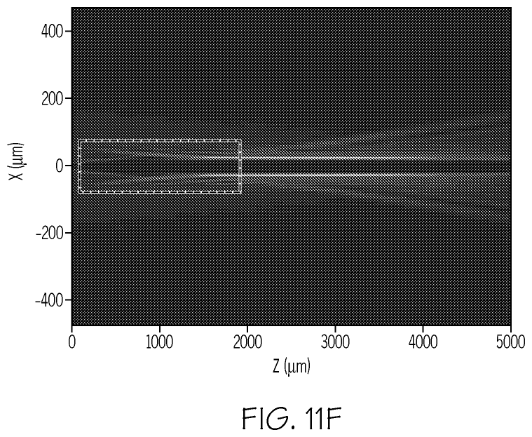

Example 5 shows a few experimental laser beam focal columns, depicted in FIGS. 11A-11F, which demonstrate the ability of the laser beam focal column to have a variable radii along its length. FIG. 11A depicts a laser beam focal column formed using a spatial light modulator that both increases and decreases in radius along the length of the laser beam focal line and FIG. 11B is a simulated image of the laser beam focal column of FIG. 11A. FIG. 11C depicts another laser beam focal column formed using a spatial light modulator that comprises a variable radii along its length, increasing and decreasing its radii multiple times along its length. FIG. 11D is a simulated image of the laser beam focal column of FIG. 11C. FIG. 11E1-11E5 depict 5 cross sections of the laser beam focal column of FIG. 11D, taken sequentially in 200 μm increments along the length of the laser beam focal column along the boxed region of the laser beam focal column of FIG. 11D. FIG. 11F depicts another example laser beam focal column formed using a spatial light modulator which applies a translating phase to the beam.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the specific value or end-point referred to is included. Whether or not a numerical value or end-point of a range in the specification recites “about,” two embodiments are described: one modified by “about,” and one not modified by “about.” It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of laser processing a transparent workpiece, the method comprising:
directing a laser beam into a transparent workpiece wherein a portion of the laser beam directed into the transparent workpiece comprises a laser beam focal column and generates an induced absorption to produce a defect column within the transparent workpiece, the laser beam focal column comprising a radius of maximum beam intensity that is variable along a length of the laser beam focal column such that the radius of maximum beam intensity comprises at least two non-zero angles of propagation with respect to a centerline of the laser beam focal column along the length of the laser beam focal column.

2. The method of claim 1, further comprising directing the laser beam through a phase altering sub-assembly prior to directing the laser beam into the transparent workpiece, wherein the phase altering sub-assembly comprises one or more optical elements configured to apply an axicon phase modification, a vortex phase modification, and a third phase modification.

3. The method of claim 2, wherein the third phase modification is a focusing phase modification.

4. The method of claim 2, wherein the third phase modification is a radially symmetric Airy phase modification.

5. The method of claim 2, wherein:
the one or more optical elements of the phase altering sub-assembly comprise an axicon and a vortex phase plate; and
the axicon is configured to apply the axicon phase modification and the vortex phase plate is configured to apply the vortex phase modification.

6. The method of claim 5, further comprising a third optical element configured to apply the third phase modification.

7. The method of claim 6, wherein the third optical element comprises a radial Airy phase plate.

8. The method of claim 6, wherein the third optical element comprises a focusing lens.

9. The method of claim 5, wherein the axicon is configured to apply the third phase modification.

10. The method of claim 5, wherein
the phase altering sub-assembly is disposed in an optical system further comprising a lens assembly comprising a first lens and a second lens; and
the vortex phase plate is disposed between the first lens and the second lens of the lens assembly.

11. The method of claim 2, wherein:
the one or more optical elements of the phase altering sub-assembly comprise one or more spatial light modulators; and
the one or more spatial light modulators are configured to apply at least one of the axicon phase modification, the vortex phase modification, and the third phase modification.

12. The method of claim 11, wherein the one or more spatial light modulators are configured to apply each of the axicon phase modification, the vortex phase modification, and the third phase modification.

13. The method of claim 12, wherein a single spatial light modulator of the one or more spatial light modulators is configured to apply each of the axicon phase modification, the vortex phase modification, and the third phase modification.

14. The method of claim 1, wherein the laser beam focal column comprises a uniform maximum intensity in the radius of maximum beam intensity along the length of the laser beam focal column.

15. A method of laser processing a transparent workpiece, the method comprising:
directing a laser beam into a transparent workpiece wherein a portion of the laser beam directed into the transparent workpiece comprises a laser beam focal column and generates an induced absorption to produce a defect column within the transparent workpiece, the laser beam focal column comprising a radius of maximum beam intensity that comprises a non-monotonic variability along the length of the laser beam focal column.

16. The method of claim 15, further comprising directing the laser beam through a phase altering sub-assembly prior to directing the laser beam into the transparent workpiece, wherein the phase altering sub-assembly comprises one or more optical elements configured to apply an axicon phase modification, a vortex phase modification, and a third phase modification.

17. The method of claim 16, wherein:
the one or more optical elements of the phase altering sub-assembly comprise one or more spatial light modulators; and
the one or more spatial light modulators are configured to apply at least one of the axicon phase modification, the vortex phase modification, and the third phase modification.

18. The method of claim 16, wherein:
the one or more optical elements of the phase altering sub-assembly comprise an axicon and a vortex phase plate; and
the axicon is configured to apply the axicon phase modification and the vortex phase plate is configured to apply the vortex phase modification.

19. The method of claim 18, wherein:
the one or more optical elements of the phase altering sub-assembly further comprise a third optical element is configured to apply the third phase modification; and
the third optical element comprises a radial Airy phase plate or a focusing lens.

20. A method for processing a transparent workpiece, the method comprising:
forming a defect column in a transparent workpiece, wherein the defect column comprises tapered end sections and forming the defect column comprises:
directing a laser beam into the transparent workpiece wherein a portion of the laser beam directed into the transparent workpiece comprises a laser beam focal column and generates an induced absorption to produce the defect column within the transparent workpiece, the laser beam focal column comprising a radius of maximum beam intensity that is variable along a length of the laser beam focal column, tapering at a divergent angle at a first end of the laser beam focal column and tapering at a convergent angle at a second end of the laser beam focal column; and
etching the transparent workpiece with a chemical etching solution to separate a portion of the transparent workpiece along the defect column, thereby forming an aperture extending through the transparent workpiece, the aperture comprising an aperture radius that varies by 10% or less along a length of the aperture.

21. The method of claim 20, wherein the aperture radius of the aperture is from 5 μm to 50 μm.

22. The method of claim 20, further comprising directing the laser beam through a phase altering sub-assembly prior to directing the laser beam into the transparent workpiece, wherein the phase altering sub-assembly comprises one or more optical elements configured to apply an axicon phase modification, a vortex phase modification, and a third phase modification.

23. The method of claim 20, wherein the aperture radius varies by 1% or less along a length of the aperture.

24. The method of claim 20, wherein the laser beam focal column comprises a uniform maximum intensity in the radius of maximum beam intensity along the length of the laser beam focal column.
